(19) United States
(12) Patent Application Publication
(10) Pub. No.: US 2018/0301908 A1
(43) Pub. Date: Oct. 18, 2018

(54) Driver with Pass-Through AC Outlet

(71) Applicant: Elemental LED, Inc., Reno, NV (US)

(72) Inventor: Matthew John, Reno, NV (US)

(21) Appl. No.: 15/953,274

(22) Filed: Apr. 13, 2018

Related U.S. Application Data
(60) Provisional application No. 62/486,304, filed on Apr. 17, 2017.

(51) Int. Cl. H02J 4/00; H01R 27/02

(52) U.S. Cl. CPC H02J 4/00; H01R 27/02

(57) ABSTRACT

A driver for supplying direct current (DC) power from an alternating current (AC) power source has an AC input and at least one DC output. The driver also has an AC outlet, which may have the form of a wall outlet, and allows multiple drivers to be connected in series, with the AC input of the next-in-series driver connected to the AC outlet of the previous-in-series driver.

### CROSS-REFERENCE TO RELATED APPLICATIONS

This application claims priority to U.S. Provisional Application No. 62/486,304, filed Apr. 17, 2017. The contents of that application are incorporated by reference in their entirety.

### BACKGROUND OF THE INVENTION

### 1. Field of the Invention

Generally, the invention relates to alternating current (AC) to direct current (DC) drivers, and more particularly to a driver with a pass-through AC outlet.

### 2. Description of Related Art

Lighting based on light-emitting diodes (LED) has become increasingly popular in recent years. Among other advantages, it offers relatively power-efficient lighting in a wide range of colors, and operates at a lower temperature, as compared with legacy incandescent bulbs.

Most LED-based lighting operates at low voltage, using direct current (DC) power. (While authorities differ somewhat on the definition of “low voltage,” for purposes of this description, the term refers to voltages below about 50V.) This can pose problems, because most household and commercial power is supplied as high-voltage alternating current (AC) power. In order to power LED lighting, the high-voltage AC power supply must be converted to low-voltage DC.

The typical means of converting AC to DC is a so-called driver—a transformer-rectifier, or other suitable circuitry, that takes high-voltage AC power as input and outputs low-voltage DC power. While some types of LED lighting have drivers built into them, in most cases, the driver is external—a rectilinear enclosure (colloquially, a “brick”) that has a high-voltage AC input and a low-voltage DC output. Drivers differ considerably in form factor, as well as in the type and nature of their inputs and outputs.

In the United States, drivers usually either have color-coded bare wire leads or plug-in connectors for input and output. In Europe, input and output terminal blocks are more common. Drivers with bare wire leads provide a great deal of flexibility in installation, but are designed to be installed by trained personnel in fixed locations. Plug-in connectors, typically a standard 2- or 3-prong household or commercial plug on the AC input and a DC barrel connector on the DC output, allow a driver to be quickly and easily connected to power and to a load. Plug-in drivers are more suitable for portable and temporary lighting installations.

Because of its advantages, LED-based lighting is often used in tight spaces, where it would not have been possible to install legacy light bulbs, like in shelving and display units. The difficulty is that the installer must also find space for the driver or drivers that power the lighting fixtures. The problem is compounded by the fact that in a typical installation, several drivers may be used to power all of the lighting fixtures, in order to keep the voltage and current outputs of any one driver within regulatory limits. This can mean that a typical LED lighting installation may involve managing a great number of wires and cables—and, in the case of plug-in drivers, finding electrical outlets to which to connect all the drivers.

### SUMMARY OF THE INVENTION

A driver according to one aspect of the invention supplies direct current (DC) power from an alternating current (AC) power source. The driver has an AC input and at least one DC output. The driver also has an AC outlet, which may have the form of a wall outlet, and allows multiple drivers to be connected in series, with the AC input of the next-in-series driver connected to the AC outlet of the previous-in-series driver.

Another aspect of the invention relates to systems that use multiple drivers of the type described above. In systems according to this aspect of the invention, the multiple drivers are connected together in series, with the AC input of the next-in-series driver connected to the AC outlet of the previous-in-series driver. Each driver is connected to an electrical load, which may, for example, be LED lighting, or a shelving system that includes LED lighting.

Other aspects, features, and advantages of the invention will be set forth in the description that follows.

### BRIEF DESCRIPTION OF THE DRAWING FIGURES

The invention will be described with respect to the following drawing figures, in which like numerals represent like elements throughout the figures, and in which:

FIG. 1 is a schematic diagram of an AC-to-DC LED driver with an AC outlet;

FIG. 2 is a illustration of the outputs of the driver of FIG. 1;

FIG. 3 is an illustration of a system using the driver of FIG. 1; and

FIG. 4 is a perspective view of a driver with an AC outlet according to another embodiment of the invention.

### DETAILED DESCRIPTION

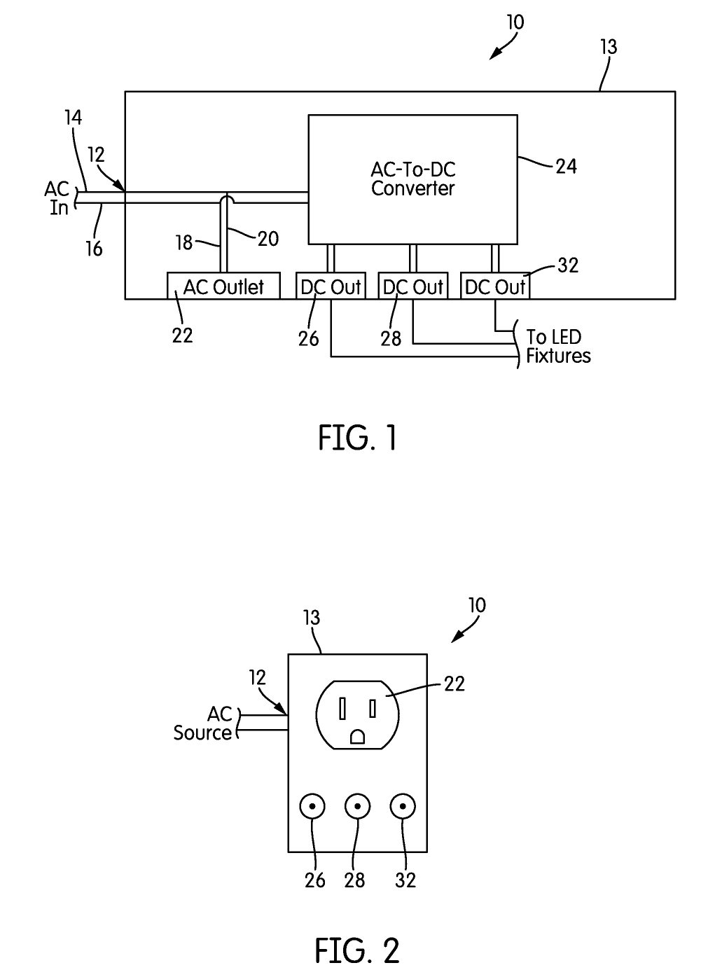

FIG. 1 is a schematic diagram of an alternating current (AC) to direct current (DC) driver, generally indicated at 10, according to one embodiment of the invention. The driver 10 receives AC power, typically at a standard household or commercial high voltage, like 110-120V, 220-240V, or 277V, and converts it to low voltage DC power. The voltage output of the driver 10 will generally suit the needs of the elements that it is to power. For example, the output voltage may be 5V, 12V, 24V, 48V or any other suitable voltage. While portions of this description will assume that the output voltage is low voltage (as defined above), it need not be.

The driver 10 may be governed by various regulatory standards meant to ensure safety, reliability, and interconnectability. For example, it may be designed and implemented as a Class 2 device CUL Standard for Safety for Class 2 Power Units, UL 1310,” Underwriters Laboratories Inc., Northbrook, Ill., the contents of which are incorporated by reference in their entirety). Such standards typically include maximum input and output voltages and currents. However, the driver 10 need not meet or be limited by any particular regulatory standard.

Generally speaking, the driver 10 has an AC input 12, which includes at least power and ground connections 14, 16. (In a typical setup, hot, neutral, and ground connections may be provided.) The AC input 12 accepts high-voltage AC power from a power source and also connects the driver 10 to the common ground of the electrical system. The manner in which the driver 10 takes AC input may vary from embodiment to embodiment. For example, the AC input 12 may be a receptacle that accepts a standard plug with a cord rated for the power. The AC input 12 may also be a cord with a plug that is fixedly attached to the driver 10. Such cords typically terminate with a strain relief portion. In yet other embodiments, the AC input 12 may be by means of other types of high-voltage wiring.

Within the driver 10, internal power and ground leads 18, 20 split off and terminate at an AC outlet 22. The AC outlet 22 thus typically supplies power at the same voltage and current levels as the AC input 12. The AC outlet 22 itself would typically have the form of a common wall outlet, although in some special-purpose embodiments, other forms of high-voltage AC outlet may be used. As will be described below in more detail, the AC outlet 22 allows an installer or user to connect several drivers 10 to each other, reducing the number of wall outlets that are necessary if multiple sets of LEDs are to be installed.

Leads from the AC power input 12 also go to AC-to-DC converter module 24 within the driver 10. The AC-to-DC converter module contains one or more circuits that convert AC to DC, typically also stepping down the voltage from high voltage to low voltage. This circuitry may be any conventional type of AC-to-DC conversion circuitry, including a transformer-rectifier, or any other circuits that can accomplish the task. The converter module 24 outputs to one or more DC power outputs 26, 28, 32. In the illustrated embodiment, there are three DC power outputs 26, 28, 32, although any number may be used in various embodiments. The power outputs 26, 28, 32 may be the same or different—in other words, each may output the same voltage using the same type of connector, each may output different voltages using the same type of connector, or each may output different voltages using different types of connectors.

While some portions of this description describe the driver 10 as a constant voltage driver, in which the voltage at the DC power outputs 26, 28, 32 is constant and the current varies with the load, the driver 10 could alternatively be a constant current driver, in which the current is held constant and the voltage is varied in accordance with the load. The type of DC power that the driver 10 provides is not critical and will vary from embodiment to embodiment and application to application.

The driver 10 itself has a housing 13. The housing 13 may be made of metal or plastic and may offer various degrees of protection against the ingress of solid contaminants (e.g., dirt or dust) and liquid contaminants (e.g., water or chemicals). The ingress protection scale is well-known to those of ordinary skill in the art. In situations in which a very high degree of ingress protection is needed, the housing 13 may be entirely filled with a water-resistant resin, such that the electrical components are potted in it. In part, this will depend on whether the driver 10 is intended for indoor or outside use.

In some cases, the AC outlet 22 may be capped or mechanically shielded, such that it is protected against the ingress of foreign material when it is not in use. When small children are likely to be present around the driver 10, the AC outlet 22 may be “childproofed” to prevent exposure to high-voltage AC.

FIG. 2 is an illustration of a face of the driver 10, illustrating one possible configuration. The AC outlet 22 has the shape, characteristics, and depth of a standard wall outlet, and may include typical features, like the ability to accept a polarized plug, or the ability to accept a three-prong grounded plug. In the illustrated embodiment, the three DC power outputs 26, 28, 32 are arranged beneath the AC outlet 22, and are configured to accept barrel connectors. However, in other embodiments, the DC power outputs 26, 28,32 may include any other type of connector, or may comprise wires or cables that are hard-connected to the driver 10. Generally speaking, the DC power outputs 26, 28, 32 may be male or female. In some embodiments, the DC power outputs 26, 28, 32 may be terminal blocks that allow for quick attachment and release of bare wires.

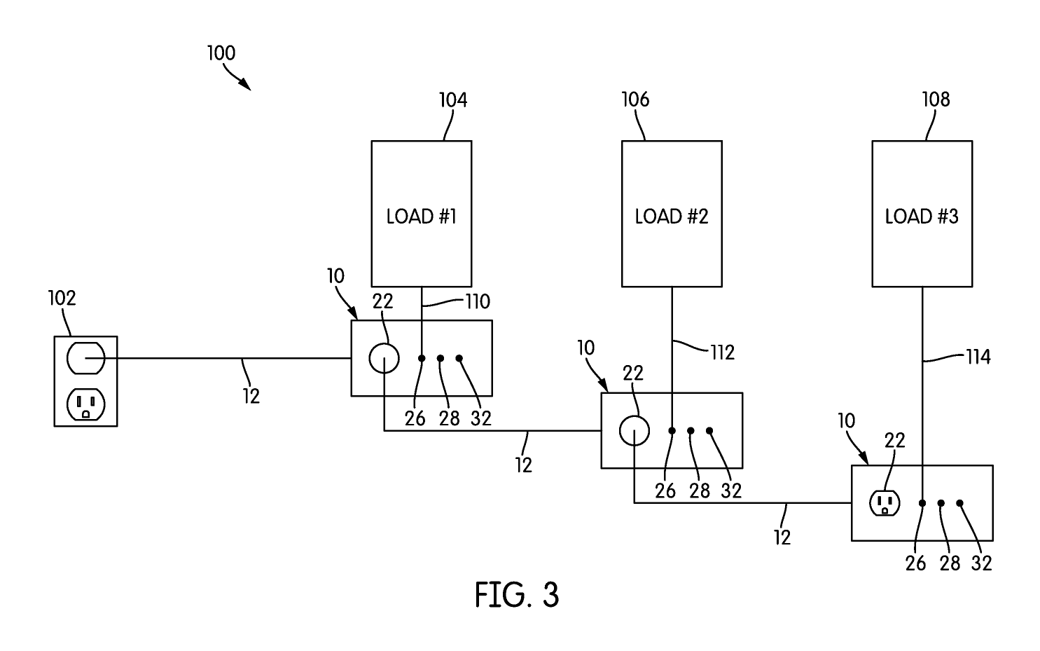

FIG. 3 is an illustration of a system, generally indicated at 100, that uses drivers 10 for power. In the system 100, three drivers 10 are used. A first driver is plugged into a standard AC wall outlet 102. The other two drivers 10 are “daisy chained” to the first—i.e., the drivers 10 are connected in series, with the power cord 12 of the next driver 10 in the series connected to the AC outlet 22 of the previous driver. This minimizes the number of wall outlets that are needed while at the same time making power available over a larger area or distance. It may also simplify wire management.

Each driver 10 powers a load 104, 106, 108. That load may, for example, be a strip or strips of linear LED lighting, or it may be a power distribution system that distributes power to LEDs. For example, the loads 104, 106, 108 may be the kinds of systems shown in U.S. Pat. Nos. 9,404,645 and 9,537,274, each of which is incorporated by reference in its entirety. A low-voltage cable 110, 112, 114 extends from one of the DC outputs 26 of each driver 10 to provide power for the loads 104, 106, 108. Of course, while this description focuses on powering LED-based lighting systems, the loads 104, 106, 108 may be of any type.

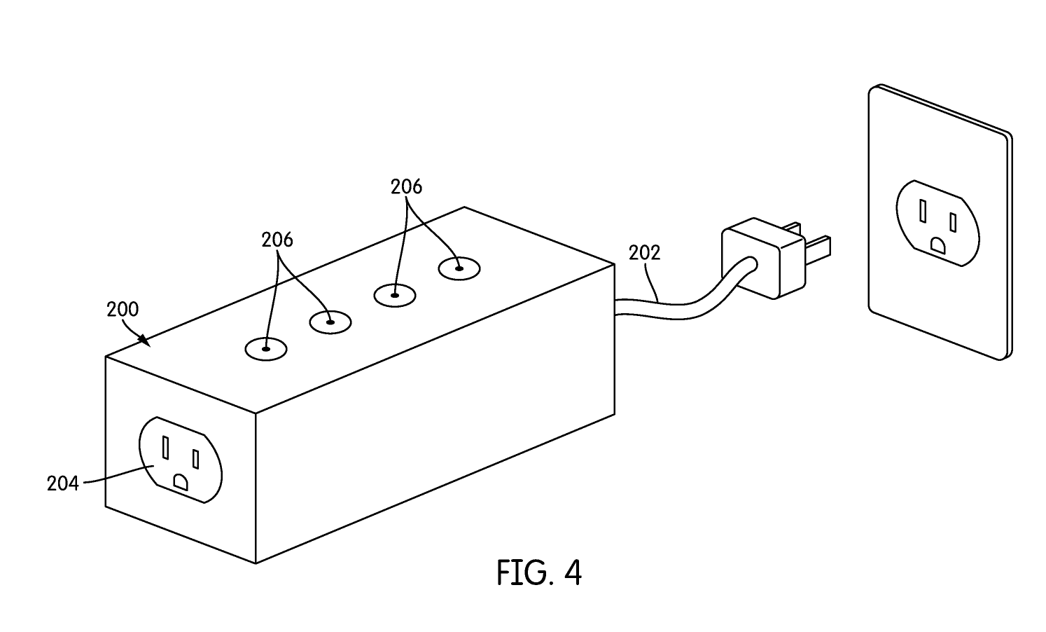

Although FIGS. 1-3 illustrate embodiments in which the driver outputs are on the same face as the AC outlet, other configurations are possible, and in some cases, may be advantageous. FIG. 4 is a perspective view of a driver, generally indicated at 200, according to another embodiment of the invention. The driver 200 has the shape of a rectangular prism. In the driver 200, the power plug 202 that serves as the AC input is on one end face of the driver 200. The AC outlet 204 is on the other end face. On one long side of the driver 200 are four DC power output ports 206. The DC power output ports may output, e.g., 12V. The driver 200 may provide, e.g., 60 W of power in total. The DC power output ports 206 are once again shown as being barrel connectors for power cables, but any suitable form of conductor, and any suitable form of connector, may be used.

One advantage of the configuration shown in FIG. 4 is that the AC power cords can run horizontally, while the DC power wiring runs vertically, presumably to individual shelves in a lighted shelving unit. This prevents the various wires or cords from tangling, and also allows the length of each DC wire or cable to be selected so that there is minimal slack.

The drivers 10, 200 shown in FIGS. 1-4 are all what are referred to as “multi-tap” drivers, in that each one has one AC input 12 and multiple DC power outlets 26, 28, 32. In this configuration, each of the DC power outlets 26, 28, 32 may provide a supply of power that is essentially independent of the others. For example, each of the DC power outlets 26, 28, 32 may provide 60 W of power at 12V, so that the driver 10 provides 180 W of power in total. However, the drivers 10, 200 need not be multi-tap drivers—each driver 10, 200 may have only one DC power outlet. Additionally, the voltages at each of the DC power outlets 26, 28, 32 may be different in some embodiments.

In that same vein, while much of this description has focused on drivers 10, 200 with a single AC outlet 22, drivers according to embodiments of the invention may have any number of AC outlets 22, and as demonstrated in FIGS. 1-4, those AC outlets 22 may be on any face or facet or in any position.

Additionally, although this description has focused largely on single-phase high-voltage AC power, the kind of power used in household and light commercial applications, a driver 10, 200 according to some embodiments of the invention may accept multi-phase power, e.g., 208V, three-phase power. If a driver 10, 200 according to an embodiment of the invention is adapted to accept multi-phase, high-voltage AC power, it may, for example, output that power at the AC outlet 22, but pass only a single phase of the power to the AC-to-DC converter 24.

While the invention has been described with respect to certain embodiments, the description is intended to be exemplary, rather than limiting. Modifications and changes may be made within the scope of the invention, which is defined by the appended claims.

What is claimed is:

1. A driver, comprising:
an alternating current (AC) input;
an AC power outlet connected to the AC input;
an AC to direct current (DC) conversion module connected to the AC input; and
one or more DC outputs connected to the AC to DC conversion circuits.

2. The driver of claim 1, wherein the AC input accepts high-voltage AC.

3. The driver of claim 2, wherein the high-voltage AC comprises a standard household or commercial voltage.

4. The driver of claim 3, wherein the AC power outlet is connected to the AC power input and outputs the high-voltage AC at the standard household or commercial voltage.

5. The driver of claim 4, wherein the driver has a plurality of faces.

6. The driver of claim 5, wherein the AC power outlet and the one or more DC outputs are physically located on a first face of the plurality of faces.

7. The driver of claim 5, wherein the AC power outlet and the one or more DC outputs are physically located on different faces of the plurality of faces.

8. The driver of claim 7, wherein the AC power outlet is physically located on an end face of the plurality of faces and the DC outputs are physically located on a side face of the plurality of faces.

9. A power system, comprising:
two or more drivers, each driver including
an alternating current (AC) input,
an AC power outlet connected to the AC input,
an AC to direct current (DC) conversion module connected to the AC input, and
one or more DC outputs connected to the AC to DC conversion circuits;
wherein the two or more drivers are connected in series such that the AC input of the next-in-series driver is connected to the AC power outlet of the previous-in-series driver.

10. The system of claim 9, wherein the AC input of each driver accepts high-voltage AC.

11. The system of claim 10, wherein the high-voltage AC comprises a standard household or commercial voltage.

12. The system of claim 11, wherein, within each driver, the AC power outlet is connected to the AC power input and outputs the high-voltage AC at the standard household or commercial voltage.

13. The system of claim 12, wherein each driver has a plurality of faces.

14. The system of claim 13, wherein, for each driver, the AC power outlet and the one or more DC outputs are physically located on a first face of the plurality of faces.

15. The system of claim 13, wherein, for each driver, the AC power outlet and the one or more DC outputs are physically located on different faces of the plurality of faces.

16. The system of claim 15, wherein, for each driver, the AC power outlet is physically located on an end face of the plurality of faces and the DC outputs are physically located on a side face of the plurality of faces.

17. A driver, comprising:
a high-voltage alternating current (AC) input accepting a specified high voltage or range of voltages;
an AC power outlet connected to the AC input, the AC power outlet outputting the specified high voltage or range of voltages;
an AC to direct current (DC) conversion module connected to the AC input, the AC to DC conversion module converting the specified high voltage or range of voltages to a specified low voltage or range of voltages;
one or more DC outputs connected to the AC to DC conversion circuits; and
a housing with a plurality of faces, the AC input, the AC power outlet, and the DC outputs being located in ones of the plurality of faces.

18. The driver of claim 17, wherein the AC power outlet and the DC outputs are located in a first face of the plurality of faces.

19. The driver of claim 17, wherein the AC power outlet and the DC outputs are located in different first and second faces of the plurality of faces.

20. The driver of claim 19, wherein the DC outputs are located in a side face of the plurality of faces and the AC power outlet is located in an end face of the plurality of faces.
